(19) United States
(12) Patent Application Publication
(10) Pub. No.: US 2025/0350129 A1
(43) Pub. Date: Nov. 13, 2025

(54) POWER SOURCE SYSTEM

(71) Applicant: DENSO CORPORATION, Kariya-city (JP)

(72) Inventor: Katsuhisa TATSUKAWA, Kariya-city (JP)

(73) Assignee: DENSO CORPORATION, Kariya-city (JP)

(21) Appl. No.: 19/279,444

(22) Filed: Jul. 24, 2025

Related U.S. Application Data
(63) Continuation of application No. PCT/JP2023/047179, filed on Dec. 28, 2023.

(30) Foreign Application Priority Data
Jan. 27, 2023 (JP) 2023-010699

(51) Int. Cl. H02J 7/00; H02J 7/14

(52) U.S. Cl. CPC H02J 7/0029; H02J 7/1492; H02J 2207/20

(57) ABSTRACT

The power source system includes a motor, an inverter, a switching control unit, a first power source that supplies power to the switching control unit, and a second power source that supplies power to the switching control unit when a short-circuit control is performed. The first power source provides power at a higher voltage than a first threshold value during normal states, while the switching control unit intermittently provides power, or provides power at a reduced voltage, or stops supplying power during an external charging. The switching control unit controls the inverter using the power supplied from the higher output voltage of the first power source and the second power source or by power supplied from the second power source during the external charging, while the switching control unit performs the short-circuit control using the power supplied from the second power source when the first power source fails.

### CROSS-REFERENCE TO RELATED APPLICATIONS

The present application is a continuation application of International Application No. PCT/JP2023/047179 filed on Dec. 28, 2023, which claims priority to Japanese Application No. 2023-010699, filed on Jan. 27, 2023. The contents of these applications are incorporated herein by reference in their entirety.

### BACKGROUND

### 1. Technical Field

This disclosure relates to a power source system.

### 2. Related Art

When an external charging is performed to charge a battery by an external power source installed outside a power source system, the voltage of the external power source may be applied to a load device along with the battery. In this case, parasitic capacitance may be generated in the load device, and the load device may operate unintentionally. To avoid such a situation, a switching device that interrupts power to the load device during the external charging may be controlled to be in an off state.

In this case, a power supply is needed for supplying power to operate the switching device during the external charging. If the power supply is a switching power source, noise is generated by the switching power source during the external charging.

In JP2022118417A, the switching power source is operated intermittently during the external charging to reduce noise. Another idea for reducing noise is to decrease the output voltage of the switching power source.

On the other hand, recent electric vehicles generally employ motors and inverters in their power units. In vehicles with motors and inverters, when the rotation speed of a motor increases, a reverse electromotive voltage generated in the coil by a magnetic flux of a permanent magnet of the motor may become larger than the voltage of the battery. Under these circumstances, when a power supply for the inverter supplying power to the inverter loses power due to an accident or other cause, the inverter cannot operate, resulting in an all-phase shutdown, and a back EMF is generated. As a result, even if, for example, an upper arm switch and a lower arm switch are all turned off, a high-voltage back EMF can be applied from the coil to the battery or electrical load via the diodes connected in parallel to the upper arm switch and the lower arm switch. In this case, the high-voltage back EMF can cause problems such as failure of batteries and other equipment. The back EMF may also cause unintended torque to be applied to the drive wheels.

Recently, an ASC control turning on one of the upper arm switch and the lower arm switch of all phases that consist of the inverter, and turning off the other, is performed as described in JP202228347A. This can suppress various problems based on the back EMF.

### SUMMARY

According to one aspect of this disclosure, a power source system can perform an external charging of a battery by an external power source. The power source system includes: a motor including windings, an inverter, including a series-connected element of a upper arm switch and a lower arm switch, that converts power between a battery and the motor, a switching control unit that controls the upper arm switch and the lower arm switch, a first power source that provides power to the switching control unit, a second power source that provides power to the switching control unit when a short-circuit control is performed, the short-circuit control being a control to turn on one of the upper arm switch and the lower arm switch and turn off the other one of the upper arm switch and the lower arm switch, and a voltage control unit that generates an instruction of an output voltage of the first power source. The first power source supplies power at a voltage higher than a first threshold value in a normal state, and supplies power intermittently, supplies power at a reduced voltage than the normal state, or stops supplying power during the external charging. The switching control unit performs the short-circuit control using the power supplied from the second power source when the first power source fails and controls the upper arm switch and the lower arm switch during the external charging using the power supplied from the higher output voltage of the first power source and the second power source. The voltage control unit instructs the first power source to output power at a voltage lower than the first threshold value and notifies the switching control unit of the instruction during the external charging. The switching control unit, when receiving the notification of the instruction from the voltage control unit, even if the output voltage of the first power source is lower than or equal to the first threshold value does not perform the short-circuit control and controls the upper arm switch and the lower arm switch using the power supplied from the second power source.

### BRIEF DESCRIPTION OF THE DRAWING

The above and other objects, features and advantages of the present disclosure will become clearer with the following detailed description with reference to the accompanying drawings. The drawings are:

FIG. 1 is a diagram of the power source system;

FIG. 2 is a diagram of the control device;

FIG. 3 is a flowchart showing the flow of control during external charging;

FIG. 4 is a flowchart showing the flow of abnormality diagnosis;

FIG. 5 is a diagram of the control device according to another embodiment;

FIG. 6 is a diagram of the control device according to another embodiment;

FIG. 7 is a diagram of the control device according to another embodiment.

### DETAILED DESCRIPTION OF THE PREFERRED EMBODIMENTS

In JP2022118417A, the switching device that interrupts power to the load device during the external charging constitutes an inverter, and the switching power source corresponds to the power supply for the inverter.

Therefore, when the ASC control described in JP202228347A is performed in a configuration where the switching power source is operated intermittently during external charging, as described in JP2022118417A, the following problems arise. That is, when the output voltage from the switching power source (power supply for the inverter) is reduced or operated intermittently during charging by an external power source, the switching power source (power supply for the inverter) may be mistakenly determined to have failed, and the ASC control may be performed. In this case, as described above, one of the upper arm switch and the lower arm switch of all phases will be turned on, the inverter cannot be operated, and charging is not performed by the external power source.

This disclosure aims to provide a power source system that can perform a short-circuit control and external charging.

According to one aspect of this disclosure, a power source system can perform an external charging of a battery by an external power source. The power source system includes: a motor including windings, an inverter, including a series-connected element of a upper arm switch and a lower arm switch, that converts power between a battery and the motor, a switching control unit that controls the upper arm switch and the lower arm switch, a first power source that provides power to the switching control unit, a second power source that provides power to the switching control unit when a short-circuit control is performed, the short-circuit control being a control to turn on one of the upper arm switch and the lower arm switch and turn off the other one of the upper arm switch and the lower arm switch, and a voltage control unit that generates an instruction of an output voltage of the first power source. The first power source supplies power at a voltage higher than a first threshold value in a normal state, and supplies power intermittently, supplies power at a reduced voltage than the normal state, or stops supplying power during the external charging. The switching control unit performs the short-circuit control using the power supplied from the second power source when the first power source fails and controls the upper arm switch and the lower arm switch during the external charging using the power supplied from the higher output voltage of the first power source and the second power source. The voltage control unit instructs the first power source to output power at a voltage lower than the first threshold value and notifies the switching control unit of the instruction during the external charging. The switching control unit, when receiving the notification of the instruction from the voltage control unit, even if the output voltage of the first power source is lower than or equal to the first threshold value does not perform the short-circuit control and controls the upper arm switch and the lower arm switch using the power supplied from the second power source.

The switching control unit can suppress the effect of the back EMF by performing the short-circuit control when the first power source fails, and the short-circuit control is reliably performed by using the power from the second power source.

On the other hand, to reduce noise from the first power source during the external charging, the first power source may be operated intermittently, for example. In this case, the switching control of the upper arm switch and the lower arm switch may not be stable with the power supplied from the first power source. Therefore, the second power source used in short-circuit control can also supply power during the external charging. This allows switching control to be reliably performed during the external charging.

Embodiments and variants in which the “power source system” of the present disclosure is applied to a vehicle (e.g., a hybrid vehicle, an electric vehicle, etc.) will be described below with reference to the drawings. In several embodiments and their variants, functionally and/or structurally corresponding and/or associated parts may be marked with the same reference symbol, or with a reference code differing by one hundred or more places. For corresponding and/or associated portions, reference may be made to the description of other embodiments.

### First Embodiment

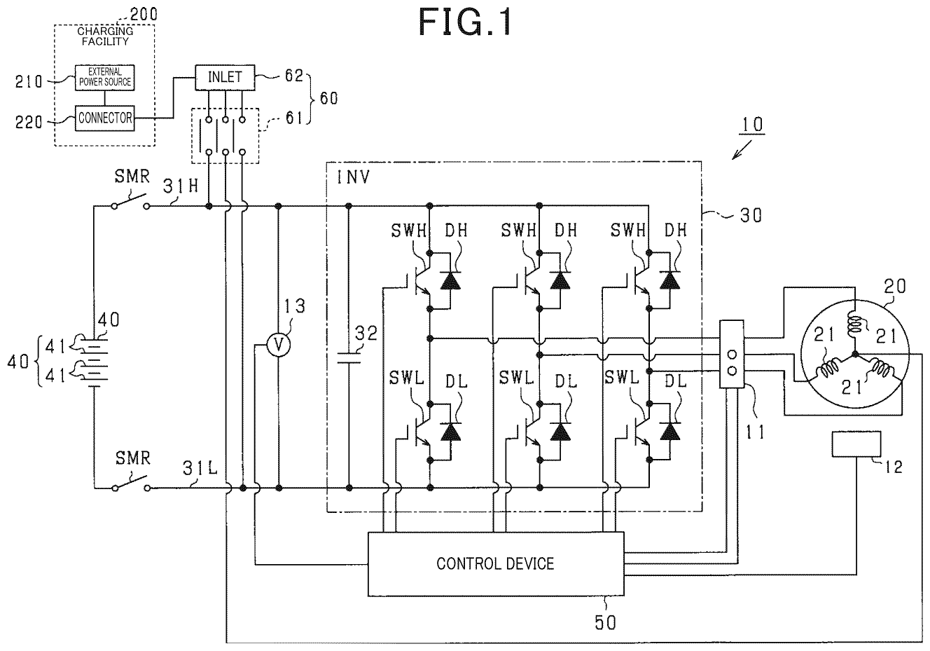

As shown in FIG. 1, a power source system 10 includes a motor 20, an inverter 30 as a power converter that applies a three-phase current to the motor 20, a battery 40 that can be charged and discharged, and a control device 50 that controls the inverter 30.

The motor 20 (motor generator) is the main onboard machine and is capable of transmitting power to drive wheels, which are not shown in the figure. In this embodiment, the motor 20 is a three-phase permanent magnet synchronous motor.

The inverter 30 is a full bridge circuit including the same number of upper and lower arms as the number of phases in phase windings. In the inverter 30, the current flow is adjusted in each phase winding by turning on and off the switches in each arm.

Specifically, the inverter 30 includes a series-connected element of an upper arm switch SWH and a lower arm switch SWL for each of three phases. In each phase, the first end of a winding 21 of the motor 20 is connected to the connection point of the upper arm switch SWH and the lower arm switch SWL. The second end of the winding 21 in each phase is connected to each other. This connection point is described as a neutral point. The windings 21 of each phase are arranged with an offset of 120° therebetween in electrical angle. In this embodiment, voltage-controlled semiconductor switching devices are used as the upper arm switch SWH and the lower arm switch SWL, more specifically, IGBTs (Insulated Gate Bipolar Transistors) are used. An upper arm diode DH, which is a freewheeling diode, is connected in reverse parallel to the upper arm switch SWH. A lower arm diode DL, which is a freewheel diode, is connected in reverse parallel to the lower arm switch SWL.

A collector, which is a high potential terminal of each of the upper arm switch SWH, is connected to a positive terminal of the battery 40 via a high voltage electrical path 31H. An emitter, which is a low potential terminal of each of the lower arm switch SWL, is connected to a negative terminal of the battery 40 via a low voltage electrical path 31L.

Relay switches SMR (system main relay switches) are provided on each of the high voltage electrical path 31H and the low voltage electrical path 31L. Each of the high voltage electrical path 31H and the low voltage electrical path 31L is switched to either an open state or a closed state by the relay switch SMR. Each of the relay switch SMR may be controlled by a control device 50 or by a host ECU 100, which is a higher-level control device relative to the control device 50.

The inverter 30 includes a smoothing capacitor 32. A first terminal of the smoothing capacitor 32 is connected to a position between the relay switch SMR and the inverter 30 in the high voltage electrical path 31H. A second terminal of the smoothing capacitor 32 is connected to a position between the relay switch SMR and the inverter 30 in the low voltage electrical path 31L. Therefore, the smoothing capacitor 32 is connected in parallel to the series-connected element of the upper arm switch SWH and the lower arm switch SWL by the high voltage electrical path 31H and the low voltage electrical path 31L. The smoothing capacitor 32 may be provided either inside or outside of the inverter 30.

The battery 40 is electrically connected to the motor 20 via the inverter 30. The battery 40 includes a plurality of battery cells 41 connected in series, and the voltage between the terminals of the battery 40 is, for example, one hundred [V] or more. The battery cells 41 may be, for example, lithium iron phosphate (LFP) batteries, lithium-ion batteries, nickel metal hydride batteries, and the like. Each of the battery cells 41 has an electrolyte (a solution comprising an electrolyte and a solvent) and a plurality of electrodes.

The power source system 10 includes an external charging mechanism 60, which includes an inlet 62 and a relay 61. The inlet 62 is connected via the relay 61 to the high voltage electrical path 31H and the low voltage electrical path 31L connecting the battery 40 and the inverter 30 respectively. The inlet 62 causes power to be supplied from an external power source 210 of the charging facility 200 to the battery 40 while an external charging is performed by causing the relay switch SMR and the relay 61 to be in an on-state (closed, energized). As shown in FIG. 1, the external charging mechanism 60 may be connected to the neutral point to enable neutral point charging.

The external charging is performed when the vehicle is connected to the charging facility 200. The charging facility 200 includes the external power source 210 and a connector 220. The connector 220 can be connected to the inlet 62 of the vehicle. The external power source 210 is, for example, a DC power source, but it can also be an AC power source. In this case, an AC/DC converter is required.

The power source system 10 includes a phase current sensor 11 and an angle sensor 12. The phase current sensor 11 detects at least two of the U, V, and W phase currents in the winding 21 of the motor 20 and outputs a current signal. The angle sensor 12 outputs an angle signal corresponding to the electric angle of the motor 20. The angle sensor 12 is, for example, a resolver, an encoder, or a MR sensor including a magneto-resistive element, which in this embodiment is the resolver. The power source system 10 also includes a voltage sensor 13 which detects the voltage between the terminals of the smoothing capacitor 32 and outputs a detection voltage VS.

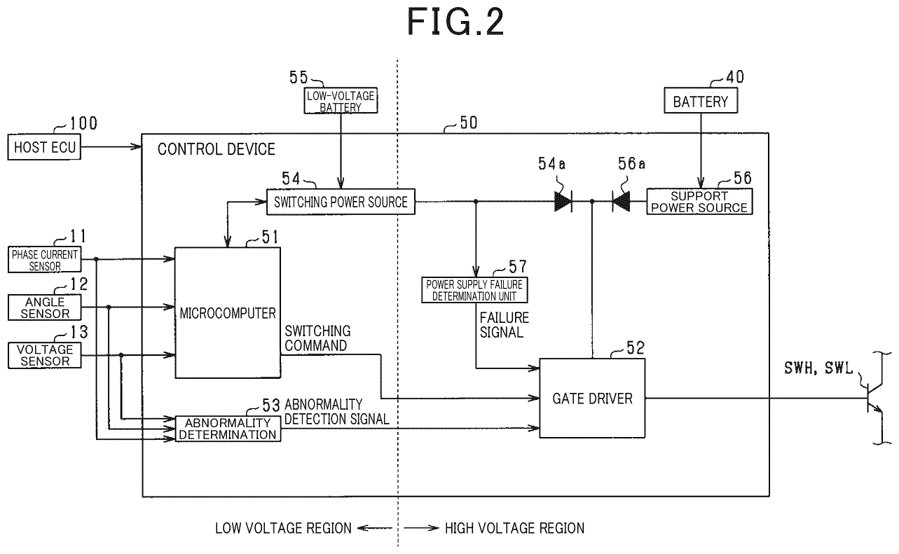

FIG. 2 is used to describe the configuration of the control device 50. The control device 50 includes a microcontroller 51 provided in a low voltage region. The microcontroller 51 includes a CPU, RAM, and ROM. The microcontroller 51 (CPU of the microcontroller 51) realizes various functions by executing programs stored in the ROM.

The current signal from the phase current sensor 11 is input to the microcontroller 51. The microcontroller 51 calculates a phase current Ir based on the input current signal. The angle signal of the angle sensor 12 is input to the microcontroller 51. The microcontroller 51 obtains the electric angle θe of the motor 20 based on the input angle signal.

The microcontroller 51 receives a command value from the host ECU 100. The microcontroller 51 generates switching commands to turn on and off the upper arm switch SWH and the lower arm switch SWL of each phase constituting inverter 30 based on the phase current Ir and the electric angle θe to cause a controlled variable of the motor 20 to approach the command value. The controlled variable is, for example, a torque.

The control device 50 includes a gate driver 52 as a switching control unit. The gate driver 52 turns on and off the upper arm switch SWH and the lower arm switch SWL of each phase based on the switching commands (on or off commands) from microcontroller 51 during a normal control.

In detail, a plurality of the gate drivers 52 are provided for the upper arm switch SWH and the lower arm switch SWL of each phase respectively. Therefore, six gate drivers 52 in total are provided. The figure is omitted in FIG. 2. Each of the gate drivers 52 supplies a charging current to the gate of the corresponding switch SWH and SWL when an on command is input. As a result, the gate voltage of the corresponding switch SWH or SWL becomes higher than a threshold value Vth, and the corresponding switch SWH or SWL is turned on. On the other hand, when an off command is input, each of the gate drivers 52 causes current to flow from the gate of the corresponding switch SWH or SWL to the emitter. As a result, the gate voltage of the corresponding switch SWH or SWL becomes lower than the threshold value Vth, and the corresponding switch SWH or SWL are turned off. In this embodiment, the gate driver 52 is provided in a high voltage region.

In addition to the normal control described above, the gate driver 52 can perform an abnormal control, which is performed to deal with anomalies such as overvoltage. In this embodiment, the abnormal control is a short-circuit control to turn off the upper arm switch SWH and turn on the lower arm switch SWL. Prior to the short-circuit control is performed, a shutdown control may be performed to force to turn off the upper arm switch SWH and the lower arm switch SWL in each phase.

In addition to the normal control and the abnormal control described above, the gate driver 52 can also perform a control during external charging, which maintains the upper arm switch SWH and the lower arm switch SWL of each phase in the off state while the external charging is being performed. The control during external charging is performed when the host ECU 100 is notified, via the microcontroller 51, that the vehicle is connected to the charging facility 200.

The control device 50 includes an abnormality determination unit 53. The detection voltage VS, the phase current Ir (or current signal), and the electric angle θe (or angle signal) are input to the abnormality determination unit 53. When any one of these values becomes abnormal, the abnormality determination unit 53 determines that at least one of the configurations used for the normal control is abnormal. The configurations used for the normal control are, for example, the phase current sensor 11, the angle sensor 12, the voltage sensor 13, the microcontroller 51, the gate driver 52, the upper arm switch SWH of each phase, the lower arm switch SWL of each phase, etc.

When the abnormality determination unit 53 determines that an abnormality has occurred, it notifies the gate driver 52 of the occurrence of the abnormality (outputs an abnormality detection signal). As a result, the gate driver 52 performs the abnormal control (the short-circuit control in this embodiment). The abnormal control is performed with higher priority than other controls (normal control, etc.). The abnormality determination unit 53 may be provided in the microcontroller 51 or in the gate driver 52. The abnormality determination unit 53 may be provided in the microcontroller 51 and the gate driver 52, respectively. The abnormality determination unit 53 may be realized by software or by hardware.

The control device 50 also includes a switching power source 54 as a first power source used when normal control is performed. The switching power source 54 is, for example, an isolated DC/DC switching power source. The switching power source 54 is connected to a low-voltage battery 55 in which an output voltage is lower than the battery 40, such as a lead-acid battery in this embodiment, and boosts the voltage of the low-voltage battery 55 to supply each of the gate drivers 52. In other words, the switching power source 54 is connected to the low-voltage battery 55 in the low voltage region and is connected to the gate drivers 52 via diode 54a in the high voltage region. In the switching power source 54, there is isolation between the low voltage region and the high voltage region. Although not shown in the figure, power is supplied from the switching power source 54 to the microcontroller 51.

Each of the gate drivers 52 operates using the power supplied from the switching power source 54 when performing the normal control. Specifically, each of the gate drivers 52, when performing the normal control, causes current to flow to the gate of each switch SWH, SWL and turns on and off each switch SWH, SWL using the power supplied from the switching power source 54.

As shown in FIG. 2, the control device 50 also includes a power supply failure determination unit 57 that determines whether the switching power source 54 has failed. The power supply failure determination unit 57 receives an output voltage from the electrical path connecting the switching power source 54 and the diode 54a and compares the output voltage with the first threshold value. When the power supply failure determination unit 57 determines that the switching power source 54 has failed, it outputs a failure signal to the gate driver 52. When the gate driver 52 receives a notification (the failure signal) from the power supply failure determination unit 57 that the switching power source 54 has failed, it performs the abnormal control in the same manner as described above. The power supply failure determination unit 57 is in the high voltage region.

The control device 50 also includes a support power source 56 as a second power source used when the abnormal control (the short-circuit control) is performed. The support power source 56 is, for example, linear power supply such as dropper power supply (also referred to as series power supply). The support power source 56, which consists of these power supplies, generally generates lower noise than the switching power source 54, but has higher heat generation losses. However, since the support power source 56 is an emergency power source used for the abnormal control, and is used for a limited period, the heat generation loss is tolerated.

The support power source 56 is in the high voltage region and is connected to the battery 40 in which the output voltage is higher than the low voltage battery 55 in the high voltage region. The support power source 56 is also connected to the gate driver 52 via a diode 56a in the high voltage region. In this embodiment, the support power source 56 regulates the input voltage of the battery 40 and supplies it to each of the gate drivers 52, respectively. Each gate driver 52 operates using the power supplied from the support power source 56 when performing the abnormal control. Specifically, each gate driver 52, when performing the abnormal control, uses the power supplied from the support power source 56 to apply current to the gate of each switch SWH and SWL, and turns on and off each switch SWH and SWL.

The switching power source 54 is connected to the microcontroller 51 in the low voltage region, and the output voltage, etc. can be controlled by the microcontroller 51. Specifically, the microcontroller 51 makes the output voltage different between when the normal control is performed and when the control during external charging is performed. For example, when the normal control is performed, the microcontroller 51 makes the output voltage higher than the second threshold value, while when the control during external charging is performed, the microcontroller 51 makes the output voltage higher than the first threshold value but lower than or equal to the second threshold value. This allows the noise from the switching power source 54 to be reduced when the control during external charging is performed, compared to when the normal control is performed.

However, when the output voltage of the switching power source 54 is reduced while the external charging is performed as described above, the margin between the first threshold value at which the power supply is determined to be failed and the output voltage becomes smaller. Therefore, it is more susceptible to noise and drop in the output voltage of the low-voltage battery 55, and the possibility that the switching power source 54 is erroneously determined to be failed using the power supply failure determination unit 57 increases. In this case, the gate driver 52 will not be able to perform the control during external charging because the abnormal control (short-circuit control) is performed in higher priority.

Therefore, in this embodiment, the support power source 56 also supplies power to the gate drivers 52 during the external charging. Specifically, each of the 52 gate drivers in this embodiment receives the power supplied from in which the output voltage is higher among the switching power source 54 and the support power source 56 during the external charging.

For example, as shown in FIG. 2, the switching power source 54 is connected to the gate driver 52 via the diode 54a in the high voltage region, and the support power source 56 is connected to the electric path connecting the diode 54a and the gate driver 52 via the diode 56a in the high voltage region. This allows each gate driver 52 to receive power supply from the higher output voltage of the switching power source 54 and the support power source 56.

The switching power source 54 supplies power at a voltage higher than the second threshold value during the normal state, and during the external charging, it supplies power at a voltage lower than the second threshold value and higher than the first threshold value. And during the external charging, the support power source 56 is also operated to supply power as described above. The output voltage of the support power source 56 is arbitrary as long as it is a voltage that can properly operate the gate driver 52, but in this embodiment, it is higher than the second threshold value in consideration of noise and other effects.

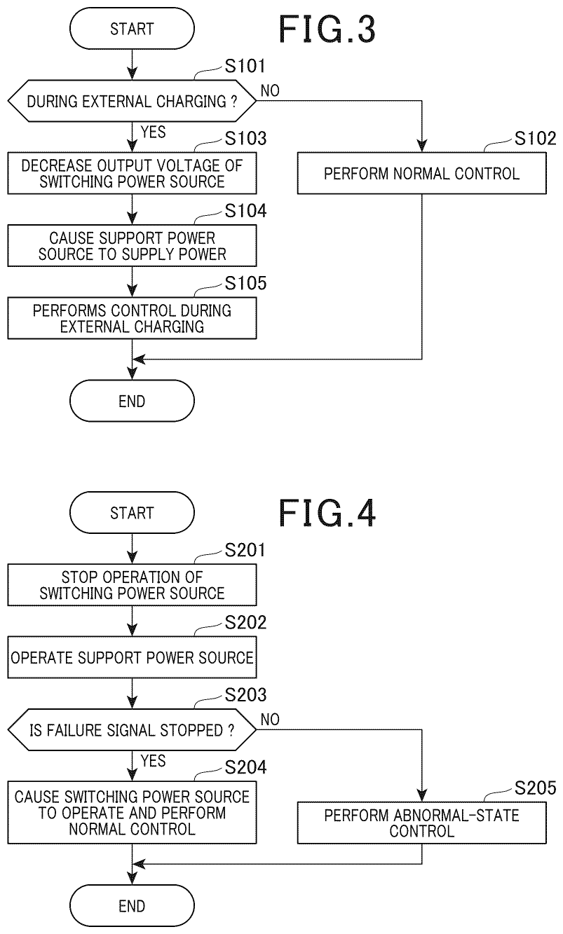

Next, the flow of control during the external charging is described with reference to FIG. 3. The microcontroller 51 determines whether the vehicle state is during the external charging (step S101). Specifically, the microcontroller 51 determines that the vehicle state is during the external charging when a notification that, the connector 220 of the charging facility 200 is connected to the vehicle inlet 62 and that power can be supplied, is input form the host ECU 100. When the determination result of step S101 is negative, the microcomputer 51 performs the normal control (step S102).

When the determination result of step S101 is positive (during the external charging), the microcontroller 51 decreases the output voltage of the switching power source 54 (step S103). Specifically, the microcontroller 51 makes the output voltage higher than the first threshold value and lower than the second threshold value.

Next, the microcontroller 51 activates the support power source 56 and causes the support power source 56 to supply power to the gate driver 52 as well as the switching power source 54 (step S104). Next, the microcontroller 51 performs the control during external charging (step S105). For example, the microcontroller 51 outputs off commands to the upper arm switch SWH and the lower arm switch SWL of each phase to cause the gate driver 52 to perform the control during external charging.

The following effects can be obtained by the first embodiment.

The gate driver 52 (switching control unit) can suppress the effect of the back EMF by performing the short-circuit control in abnormal conditions, such as when the switching power source 54 (the first power source) is failed. In this case, the gate driver 52 reliably performs the short-circuit control by using power from the support power source 56 (the second power source).

On the other hand, during the external charging, the output voltage of the switching power source 54 is reduced to reduce noise from the switching power source 54. In this case, there is a possibility that the upper arm switch SWH and the lower arm switch SWL cannot be stably controlled using the power supplied from the switching power source 54. Therefore, the system is configured so that the power can also be supplied to the gate driver 52 from the support power source 56 during the external charging as well as during the short-circuit control. This ensures that switching control can be performed during the external charging.

Isolation is required in the circuit design where the switching power source 54 is in the low voltage region and the gate driver 52 is in the high voltage region. Therefore, the switching power source 54 generates higher noise. On the other hand, since the switching power source 54 is in the low voltage region, it has the advantage that the heat loss can be reduced and the power consumption can be lower even after long-term use under normal conditions.

Since the gate driver 52 and the support power source 56 are in the same high voltage region, there is no need to consider insulation, and since they are emergency power supplies, there is no need to care about heat generation loss or power loss. Therefore, it is possible to use a linear power supply and make the noise lower when used during the external charging.

Since the support power source 56 is the high voltage region, the heat generation loss is larger, and the power consumption tends to be higher. However, this disadvantage can be tolerated because it is used during a limited period when the switching power source 54 fails or during external charging, i.e., it is an emergency power supply.

During the external charging, the switching power source 54 supplies the power at a voltage lower than the supply voltage in the normal state (the second threshold value) and higher than the first threshold value, which is determined to be abnormal. Therefore, in the normal control, power can be stably supplied from the switching power source 54 to the gate driver 52 during external charging, while noise can be reduced during external charging. In addition, it is possible to easily detect the abnormality of the switching power source 54.

### Second Embodiment

Some of the configurations of the first embodiment may be changed. The following is a description of a second embodiment in which some of the configuration of the first embodiment is changed.

In the second embodiment, the microcontroller 51 operates the support power source 56 and causes the support power source 56 to supply power to the gate driver 52 while the switching power source 54 is stopped during the external charging.

When the switching command (on or off command) is input from the microcontroller 51 and the failure signal of the switching power source 54 is input from the power supply failure determination unit 57, the gate driver 52 processes the failure signal as invalid (masks the failure signal).

This allows the gate driver 52 to perform the control during external charging without the short-circuit control even if the switching power source 54 is intentionally stopped by the instruction of the microcontroller 51 during the external charging and thereby the power supply failure determination unit 57 outputs a failure signal.

When the switching power source 54 actually fails, the power supply from the switching power source 54 to the microcontroller 51 is also cut off, so no switching commands are input from the microcontroller 51. In other words, when the switching power source 54 actually fails, the gate driver 52 executes the abnormal control upon input of the failure signal.

According to the configuration of the second embodiment, control of the switching power source 54 can be simplified during the external charging.

### Third Embodiment

Some of the configurations of the first embodiment above may be changed. The following is a description of a third embodiment in which some of the configurations of the first embodiment are changed.

In the third embodiment, the power source system 10 has a diagnostic function to diagnose whether the support power source 56 can operate normally. The following is a detailed description.

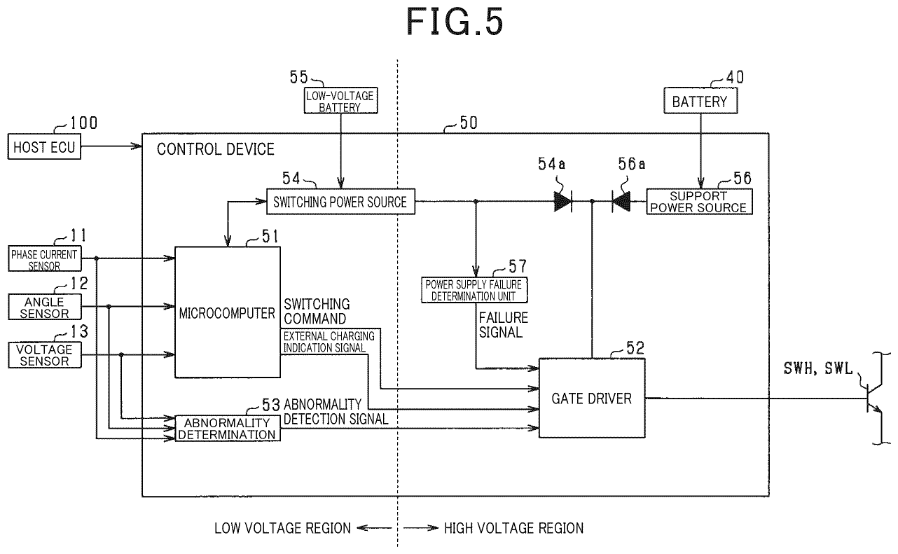

The gate driver 52 outputs the failure signal to the microcontroller 51 when the power supply voltage applied by the switching power source 54 or the support power source 56 falls below the lower limit voltage for the operation. Therefore, at a predetermined timing (e.g., at vehicle startup), the microcontroller 51 performs the diagnostic process shown in FIG. 4 to intentionally stop the operation of the switching power source 54 (step S201). As a result, the failure signal is input to the microcontroller 51 from the gate driver 52.

Next, the microcontroller 51 operates the support power source 56 (step S202) to determine whether the failure signal has stopped being outputted by supplying power from the support power source 56 to the gate driver 52 (step S203).

When the determination result is positive, that is, when the failure signal has stopped being outputted, the microcomputer 51 determines that the support power source 56 is operating normally and starts performing the normal control (step S204). On the other hand, when the determination result is negative, that is, when the failure signal has not stopped being outputted, the microcomputer 51 determines that the support power source 56 is not operating normally and starts performing the abnormal control (step S205).

According to the third embodiment, the state of the support power source 56 can be easily checked and the gate driver 52 can reliably perform the abnormal control (the short-circuit control) and the control during external charging.

### <Variants>

The following is a description of variants in which some of the configuration of the above embodiments is changed.

In the second embodiment, when the gate driver 52 receives the switching command (on or off command) from the microcomputer 51 and the failure signal of the switching power source 54 from the power supply failure determination unit 57, the failure signal is processed as invalid. As a variation of this method, as shown in FIG. 5, during the external charging, the microcontroller 51 may input an external charging indication signal to the gate driver 52 via a dedicated line provided separately from the signal line that outputs the switching commands, notifying that it is in the external charging state. This ensures that the gate driver 52 recognizes that the external charging is taking place, even if the switching command is not correctly input due to noise effects, etc.

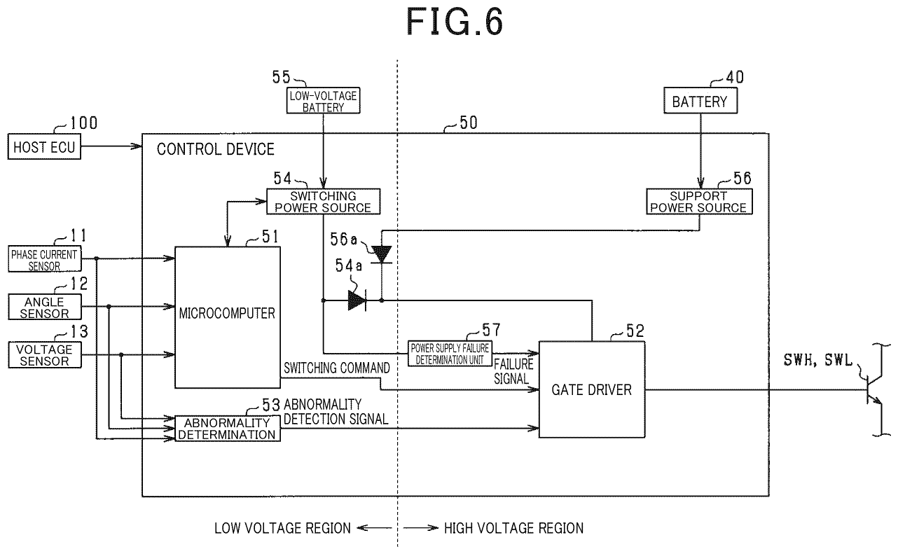

In the above embodiments, the support power source 56 is connected to the gate driver 52 in the high voltage region, but it may be connected to the electric path, which connects the switching power source 54 and the diode 54a, in the low voltage region, as shown in FIG. 6. In this case, the power supply failure determination unit 57 inputs the output voltage of the switching power source 54 from the electric path, which connects the switching power source 54 and the diode 54a in the low voltage region.

In the above embodiments, when the control during external charging is performed, the microcontroller 51 controls the switching power source 54 to output a voltage higher than the first threshold value and lower than or equal to the second threshold value. As a variation of this embodiment, when the control during external charging is performed, the microcontroller 51 may cause the voltage to be output intermittently from the switching power source 54.

In the above embodiments, the power supply failure determination unit 57 may determine that the switching power source 54 has failed when the output voltage of the switching power source 54 is lower than or equal to the second threshold value during the normal state, and the power supply failure determination unit 57 may determine that the switching power source 54 has failed when the output voltage of the switching power source 54 is lower than or equal to the first threshold value during the external charging. In other words, the threshold value may be changed between the normal state and the during external charging.

In the above embodiments, the power supply failure determination unit 57 may be provided inside the gate driver 52.

The power source system 10 of the above embodiments may be configured to allow neutral point charging.

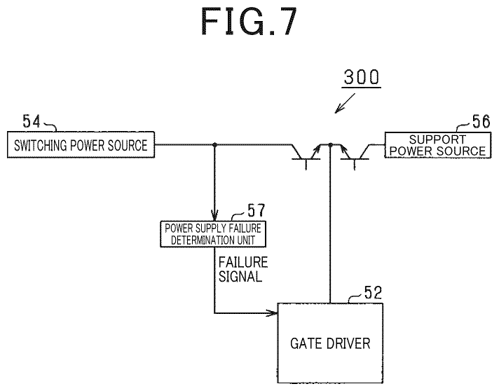

In the above embodiment, gate driver 52 may be connected to the switching power source 54 and the support power source 56 via a wired OR circuit 300 using transistors or the like, as shown in FIG. 7.

In the above embodiment, an isolated power supply is provided as the switching power source 54, but a non-isolated type may also be provided. In this case, it is necessary to provide a circuit for isolation between the switching power source 54 and the gate driver 52.

The following is a description of the characteristic configurations extracted from each of the above-mentioned embodiments.

### [Configuration 1]

A power source system (10) capable of performing an external charging of a battery (40) by an external power source (210), the power source system including:
a motor (20) including windings (21);
an inverter (30), including a series-connected element of an upper arm switch (SWH) and a lower arm switch (SWL), that converts power between a battery and the motor;
a switching control unit (52) that controls the upper arm switch and the lower arm switch;
a first power source (54) that provides power to the switching control unit; and
a second power source (56) that provides power to the switching control unit when a short-circuit control is performed, the short-circuit control being a control to turn on one of the upper arm switch and the lower arm switch and turn off the other one of the upper arm switch and the lower arm switch
wherein
the first power source supplies power at a voltage higher than a first threshold value in a normal state, and supplies power intermittently, supplies power at a reduced voltage than the normal state, or stops supplying power during the external charging,
the switching control unit performs the short-circuit control using the power supplied from the second power source when the first power source fails and controls the upper arm switch and lower arm switch during the external charging using the power supplied from the higher output voltage of the first power source and the second power source.

### [Configuration 2]

The power source system according to configuration 1, wherein
at least the switching control unit and the second power source are in a high voltage region, and
the first power source is in a low voltage region.

### [Configuration 3]

The power source system according to configurations 1 or 2, wherein
the first power source provides power at a higher voltage than a second threshold value during the normal state, during the external charging, it provides power at a voltage lower than the second threshold value and higher than the first threshold value, and
the switching control unit, when the output voltage of the first power source is lower than or equal to the first threshold value, determines that the first power source has failed and performs the short-circuit control using the power supplied from the second power source.

### [Configuration 4]

The power source system according to configurations 1 or 2, further including a voltage control unit (51) that generates an instruction of an output voltage of the first power source,
wherein the voltage control unit instructs the first power source to output power at a voltage lower than the first threshold value and notifies the switching control unit of the instruction during the external charging, and
the switching control unit, when receiving the notification of the instruction from the voltage control unit, even if the output voltage of the first power source is lower than the first threshold value does not perform the short-circuit control and controls the upper arm switch and the lower arm switch using the power supplied from the second power source.

### [Configuration 5]

The power source system according to configurations 1 or 2, further including a switch control unit (51) that instructs the on and off state of the upper arm switch and the lower arm switch,
wherein the switch control unit is operated by power from the first power source, and
when instructed by the switch control unit, the switching control unit controls the upper arm switch and the lower arm switch according to the instructions from the switch control unit, even if the output voltage of the first power source is lower than or equal to the first threshold value, without performing the short-circuit control.

### [Configuration 6]

The power source system according to configurations 1 or 2, further including a voltage control unit (51) that instructs the output voltage of the first power source,
wherein the voltage control unit can perform abnormality diagnosis processing,
in the abnormality diagnosis process, the voltage control unit instructs the first power source to output power at a lower voltage than the first threshold value, and when the short-circuit control is subsequently performed by the switching control unit using the power supplied from the second power source, the voltage control unit diagnoses that the second power source is operating normally, and when the short-circuit control is not performed, the voltage control unit diagnoses that an abnormality occurs.

Although this disclosure has been described in accordance with examples, it is understood that this disclosure is not limited to the examples or structures. The present disclosure also encompasses various variations and transformations within the scope of equality. In addition, various combinations and forms, as well as other combinations and forms including only one element, more or less, thereof, also fall within the scope and idea of this disclosure.

What is claimed is:

1. A power source system capable of performing an external charging of a battery by an external power source, the power source system comprising:
a motor including windings;
an inverter, including a series-connected element of an upper arm switch and a lower arm switch, that converts power between a battery and the motor;
a switching control unit that controls the upper arm switch and the lower arm switch;
a first power source that provides power to the switching control unit;
a second power source that provides power to the switching control unit when a short-circuit control is performed, the short-circuit control being a control to turn on one of the upper arm switch and the lower arm switch and turn off the other one of the upper arm switch and the lower arm switch; and
a voltage control unit that generates an instruction of an output voltage of the first power source,
wherein
the first power source supplies power at a voltage higher than a first threshold value in a normal state, and supplies power intermittently, supplies power at a reduced voltage than the normal state, or stops supplying power during the external charging,
the switching control unit performs the short-circuit control using the power supplied from the second power source when the first power source fails, and controls the upper arm switch and lower arm switch during the external charging using the power supplied from the higher output voltage of the first power source and the second power source,
the voltage control unit instructs the first power source to output power at a voltage lower than the first threshold value and notifies the switching control unit of the instruction during the external charging, and
the switching control unit, when receiving the notification of the instruction from the voltage control unit, even if the output voltage of the first power source is lower than the first threshold value does not perform the short-circuit control and controls the upper arm switch and the lower arm switch using the power supplied from the second power source.

2. The power source system according to claim 1, wherein
at least the switching control unit and the second power source are in a high voltage region, and
the first power source is in a low voltage region.
